(19) United States
(12) Patent Application Publication
(10) Pub. No.: US 2010/0206298 A1
(43) Pub. Date: Aug. 19, 2010

(54) SOLAR RECEIVERS AND SYSTEMS THEREOF

(75) Inventor: Jacob Karni, Rehovot (IL)

Correspondence Address: THE NATH LAW GROUP, 112 South West Street, Alexandria, VA, 22314, US

(73) Assignee: YEDA RESEARCH AND DEVELOPMENT COMPANY LTD., Rehovot (IL)

(21) Appl. No.: 12/675,517

(22) PCT Filed: Aug. 31, 2008
(86) PCT No.: PCT/IL08/01180

§ 371 Date: Feb. 26, 2010

Related U.S. Application Data
(60) Provisional application No. 60/969,088, filed on Aug. 30, 2007.

(51) Int. Cl. F24J 2/24; F24J 2/46; F24J 2/00; F03G 6/06

(52) U.S. Cl. 126/651; 126/704; 126/701; 60/641.15

(57) ABSTRACT

A solar receiver is disclosed and includes a housing having a front, radiation-facing, end and a rear end, the front end being formed with a cavity therein. A window is mounted at the front end of the housing and projects inside the cavity. A receiver chamber is defined within the cavity between the housing and the window. The receiver chamber has a working fluid inlet for ingress of working fluid to be heated therewithin, and a working fluid outlet for egress therethrough of the heated fluid. A solar absorber is within the receiver chamber for absorbing the solar radiation and heating the working fluid. The solar absorber includes at least one tubular member configured for maintaining fluid isolation between contents thereof and contents of the receiver chamber. The solar absorber is configured for heating working fluid within the receiver chamber exterior to the tubular member, and working fluid within the tubular member.

### FIELD OF THE INVENTION

The present invention relates generally to solar energy systems and more particularly to solar energy systems with solar receivers.

### BACKGROUND OF THE INVENTION

Turbines are commonly used to produce electrical power. Typically, a working fluid, such as air, steam or any other gas, is compressed and heated before being supplied to the turbine, wherein the working fluid is expanded and some of the energy content of hot, compressed working fluid is converted to mechanical motion which is then converted to electricity by use of a generator.

In solar energy systems one device known in the art for heating the working fluid prior to entering the turbine is a solar receiver. Such a receiver utilizes solar radiation which impinges upon a solar radiation absorber within the solar receiver. The working fluid is heated by the absorber, and thereafter the working fluid transfers the heat via the turbine for producing electrical power therefrom. Additionally, heat exchangers, chemical reactions, or any other suitable apparatus or process may be used to generate electricity from the heated working fluid.

### SUMMARY OF THE INVENTION

According to one aspect of the present invention, there is provided a solar receiver, which may be a central solar receiver, for receiving concentrated solar radiation and heating a working fluid, the solar receiver comprising:
a housing having a front, radiation-facing, end and a rear end, the front end being formed with a cavity therein;
a window mounted at the front end of the housing and projecting inside the cavity;
a receiver chamber defined within the cavity between the housing and the window, the receiver chamber having a working fluid inlet for ingress of working fluid to be heated therewithin, and a working fluid outlet for egress therethrough of the heated fluid; and
a solar absorber within the receiver chamber for absorbing the solar radiation and heating the working fluid, the solar absorber comprising at least one tubular member configured for maintaining fluid isolation between contents thereof and contents of the receiver chamber, the solar absorber being configured for concurrently heating:
   working fluid within the receiver chamber exterior to the tubular member; and
   working fluid within the tubular member.

The window and cavity may be elongated toward the rear end of the housing, with the solar absorber extending around and along the window.

The receiver chamber may be in fluid communication with the interior of the solar absorber via at least one of the working fluid inlet and working fluid outlet.

The solar receiver may further comprise a radiation shield disposed within the fluid path between the working fluid inlet and the absorber.

An outlet of the solar absorber may be in fluid communication with a first turbine. A first combustor may be located between the solar absorber and the first turbine. An outlet of the first turbine may be in fluid communication with the working fluid inlet of the receiver chamber.

The working fluid outlet of the receiver chamber may be in fluid communication with a second turbine. A second combustor may be located between the solar absorber and the second turbine. The working fluid outlet of the receiver chamber may be in fluid communication with an inlet of the solar absorber.

The solar receiver may further comprise a pre-heater, which may be a heat exchanger, at the entrance of the working fluid inlet.

The solar absorber may be configured to maintain the working fluid therewithin at a first pressure when the pressure of the working fluid within the receiver chamber is at a second pressure, the pressure difference between the first and second pressures being substantially greater than 10 bar, or substantially greater than 20 bar.

The solar receiver may further comprise a cooling system configured to maintain a low temperature at the area of contact between the window and the housing. The cooling system may comprise a cooling fluid path adjacent or concurrent with the area. The cooling fluid path may be in fluid communication with at least one of the receiver chamber and the interior of the solar absorber.

The working fluid may be used to drive a turbine, the solar receiver further comprising a recuperator, configured to utilize exhaust heat from the turbine to heat fluid, disposed between the cooling fluid path and the at least one of the receiver chamber and the interior of the solar absorber.

The window may be formed comprising a paraboloid of revolution.

According to another aspect of the present invention, there is provided a solar energy system comprising:
a solar receiver as described above; and
a turbine configured to receive the fluid exiting the working fluid outlet and utilize the fluid, in particular the heat thereof, to generate electricity.

### BRIEF DESCRIPTION OF THE DRAWINGS

The present invention will be understood and appreciated more fully from the following detailed description of a non-limiting example, taken in conjunction with the drawings in which:

FIGS. 1A & 1B are oppositely facing simplified pictorial illustrations of a solar receiver constructed and operative in accordance with an embodiment of the present invention;

FIG. 2 is a simplified partially pictorial, partially sectional illustration taken along lines II-II in FIG. 1A;

FIG. 3 is a simplified partially pictorial, partially sectional illustration taken along lines in FIG. 1A;

FIG. 4 is a simplified partially pictorial, partially sectional illustration taken along lines IV-IV in FIG. 1A;

FIG. 5 is a simplified partially pictorial, partially sectional illustration taken along lines V-V in FIG. 2;

FIG. 6 is a simplified partially pictorial, partially schematic illustration of the solar receiver of FIGS. 1A through 5 associated with a solar energy system constructed and operative in accordance with an embodiment of the present invention;

FIGS. 7A & 7B are oppositely facing simplified pictorial illustrations of another solar receiver constructed and operative in accordance with an embodiment of the present invention;

FIG. 8 is a simplified partially pictorial, partially sectional illustration taken along lines VIII-VIII in FIG. 7A; and

FIG. 9 is a simplified partially pictorial, partially schematic illustration of the solar receiver of FIGS. 7A through 8 associated with a solar energy system constructed and operative in accordance with an embodiment of the present invention.

### DETAILED DESCRIPTION OF THE PRESENT INVENTION

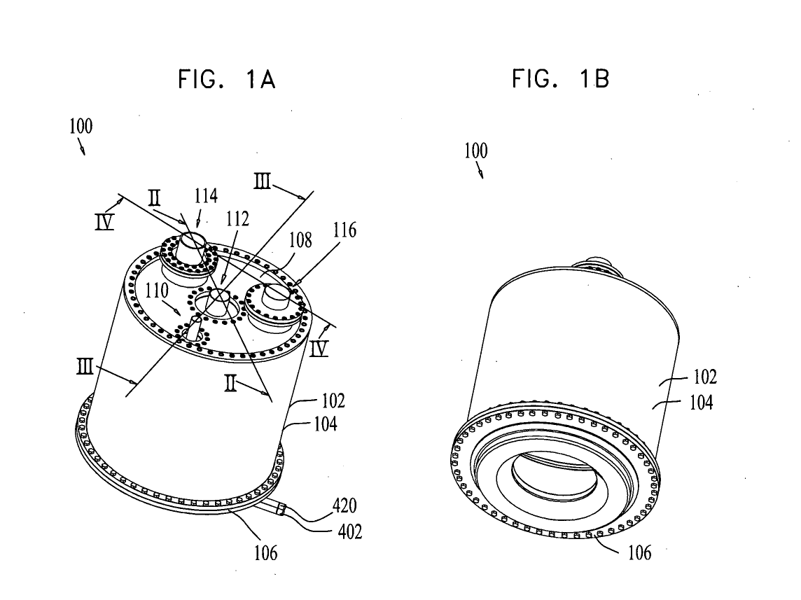

As seen in FIG. 1A through 5, a solar receiver 100, configured to be incorporated within a solar energy system (not illustrated in FIGS. 1 through 5A), is provided. The solar receiver 100 comprises a receiver housing 102 formed of stainless steel or any other suitable material. Housing 102 comprises a generally cylindrical main portion 104 formed with a base portion 106 at a front, radiation facing end thereof, and a top portion 108 at a rear end thereof. Protruding from top portion 108 are a first fluid inlet conduit assembly 110, a first fluid outlet conduit assembly 112, a second fluid inlet conduit assembly 114 and a second fluid outlet conduit assembly 116.

Main portion 104 is engaged with top portion 108 by any suitable means, such as by a peripheral protrusion 120, protruding from main portion 104 and mounted onto top portion 108, by fastening members 124, which may be screws or any other suitable arrangement. An O-ring 126, or any other suitable sealing arrangement, may be disposed between the main portion, e.g., protrusion 120 thereof as illustrated, and top portion 108. O-ring 126, or the sealing arrangement, is provided to ensure a tightly sealed engagement between the main portion 104 and the top portion 108.

Main portion 104 is engaged with base portion 106 by any suitable means, such as by a peripheral protrusion 130, protruding from main portion 104 and mounted to base portion 106, by fastening members 134, which may be screws or any other suitable arrangement. An O-ring 136, or any other suitable sealing arrangement, may be disposed between the main portion, e.g., protrusion 130 thereof as illustrated, and base portion 106. O-ring 136, or the sealing arrangement, is provided to ensure a tightly sealed engagement between the main portion 104 and the base portion 106.

It is noted that while housing 102 is illustrated as being generally cylindrical in shape, it may be shaped in any suitable form.

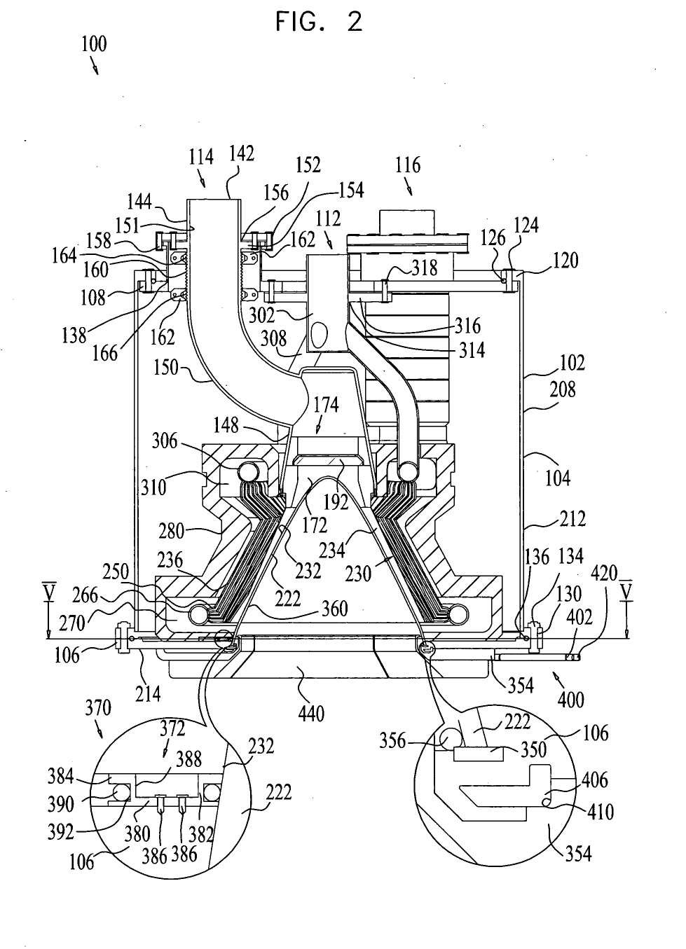

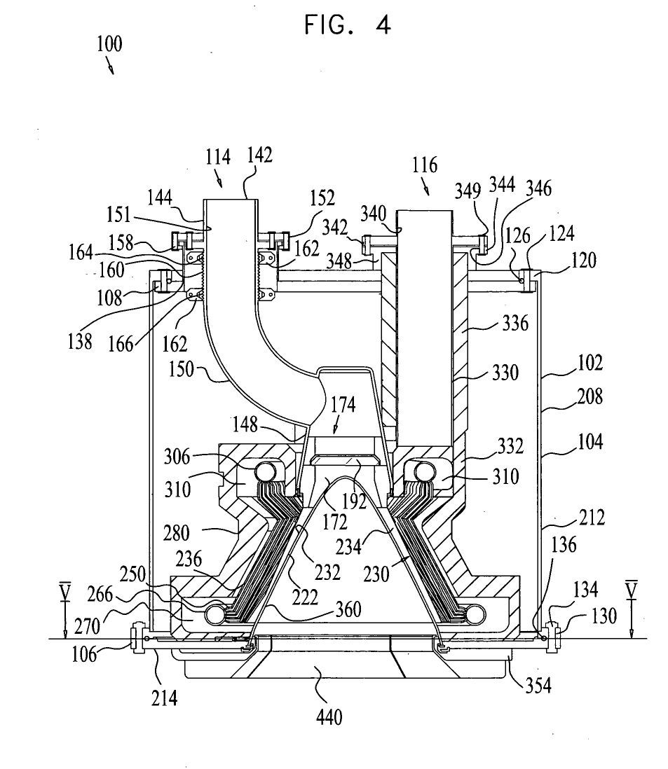

As best seen in FIGS. 2 and 4, second inlet conduit assembly 114 comprises an inlet conduit housing 138 and a conduit 142. Inlet conduit housing 138 protrudes from top portion 108. Inlet conduit 142 is formed of a generally cylindrical portion 144, a generally central inlet conduit portion 148, and a generally rounded portion 150. Cylindrical portion 144 is partially disposed within inlet conduit housing 138. Central inlet conduit portion 148 is disposed within cylindrical portion 104 of receiver housing 102 and is in fluid communication with cylindrical portion 144 via angular portion 150. Inlet conduit 142 may be formed of stainless steel or any other suitable material.

Cylindrical portion 144 defines on a top portion 151 thereof a peripheral protrusion 152 protruding therefrom. Peripheral protrusion 152 is mounted onto a peripheral protrusion 154, protruding from a rim 156 of inlet housing 138, via fastening members 158, which may be screws or any other suitable arrangement.

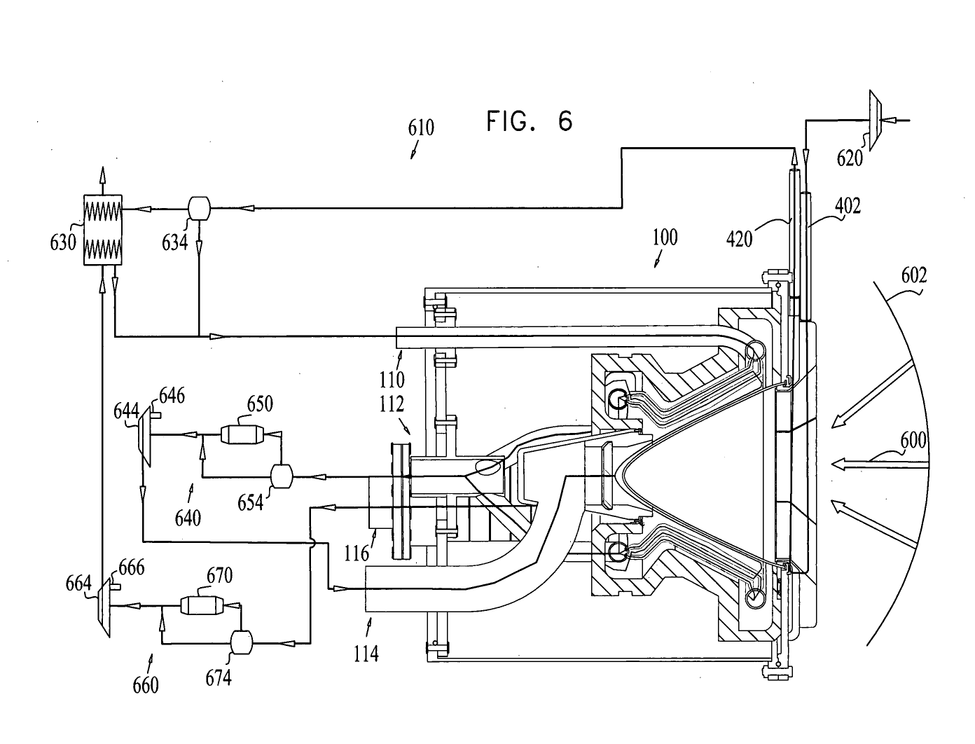

A bellows 160 may be disposed about cylindrical portion 144 and is provided to absorb the thermal expansion of inlet conduit 142 during heating thereof by a relatively high-temperature working fluid flowing therein, as will be further described hereinbelow with reference to FIG. 6. Bellows 160 may be formed of any suitable material, such as, e.g., stainless steel or a suitable elastomeric material.

Bellows clamps 162 may be provided on a top portion 164 and on a bottom portion 166 of bellows 160 so as to secure it to cylindrical portion 144 of inlet conduit 142.

Central inlet conduit portion 148 surrounds a central radiation shield enclosure 172 of a radiation shield assembly 174. Enclosure 172 is formed of an insulating material, e.g., a ceramic material. Enclosure 172 is formed to thermally insulate the radiation shield assembly 174 from the surrounding inlet conduit 142 so as to prevent overheating of the inlet conduit 142 due to flow of relatively high-temperature working fluid through radiation shield assembly 174.

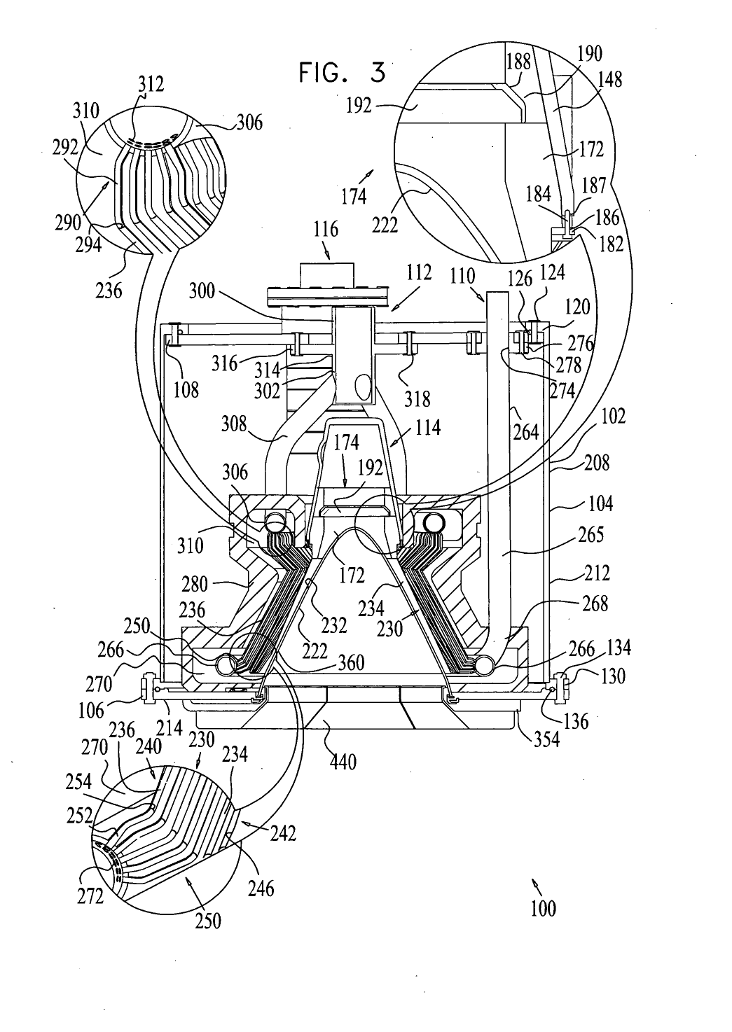

As illustrated in an inset of FIG. 3, a peripheral ring support 182, formed of stainless steel or any other suitable material, may be provided. Ring support 182 may be engaged with central inlet conduit portion 148 by fastening members 184, which may be screws or any other suitable arrangement, inserted within throughgoing bores 186 defined within ring support 182 and bores 187 defined within central inlet conduit portion 148.

Enclosure 172 comprises an annular recess 188 in a middle portion 190 thereof. A radiation shield 192 is seated within recess 188 and may be formed of any suitable material, such as a ceramic material or metal adopted to withstand relatively high temperatures. Radiation shield 192 may be formed of tubes, pins, a perforated material or any suitable material allowing fluid to flow therethrough.

The radiation shield 192 is located so that it may serve as a thermal barrier between a first, radiation shielded, portion 208 of the receiver 100, which extends generally between the radiation shield 192 and the top portion 108 of the receiver housing, and a second, radiation exposed, portion 212 of receiver 100, which extends generally between the radiation shield 192 and a bottom surface 214 of base portion 106. The conduit assemblies 110, 112, 114, 116 are located within the first portion 208, so as to be shielded from radiation. A window 222 and absorber 230 (described below) are located within the second portion 212, and thus are not shielded by the radiation shield 192 from impinging solar radiation.

An elongated window 222 is provided, mounted at the front end and disposed so as to project within a cavity formed in the second portion 212 of receiver 212. Window 222 is designed so as to allow solar radiation to impinge thereon and penetrate therethrough, as will be further described hereinbelow with reference to FIG. 6.

Window 222 may be shaped, e.g., as a portion of a paraboloid of revolution, as a portion of a hyperbolic paraboloid, or as any suitable geometric configuration defining a streamlined contour wherein there is no profile transition from one geometric shape to another. The streamlined contour minimizes turbulent flow of the working flowing along the window 222 and minimizes reflection losses of incoming solar radiation therethrough. Additionally, the streamlined contour obviates tensile stresses on the window 222 caused e.g., by profile transitions, and allows for increased accuracy in production thereof.

It is noted that window 222 may be shaped in any suitable conical-like or frusto-conical-like configuration, a geometric configuration defining a streamlined contour comprising more than one type of geometric shape wherein there is a profile transition from one geometric shape to another, or any other suitable form so as to allow solar radiation to impinge thereupon and working fluid to flow therearound. Window 222 may be formed of any suitable material able to withstand relatively high temperatures and admit solar radiation therein. For example, window 222 may be formed of fused quartz.

A solar radiation absorber 230 is disposed around and along an external surface 232 of window 222 defining a fluid channel 234 in the vicinity therebetween. The absorber is designed so as to maintain fluid isolation between the interior and exterior portions thereof, at least within the fluid channel. Solar radiation absorber 230 comprises a plurality of absorber members, such as tubes 236 extending along and around outer surface 232 of window 222. Tubes 236 may be formed of an austenitic nickel-based superalloy such as that sold under the trade-name INCONEL®, or any other suitable material able to withstand relatively high temperatures. Tubes 236 may be arranged in tubular arrays, such as a tubular array 240 overlying additional tubular arrays 242, as illustrated in an inset in FIG. 3. An external surface of each tube 236 is designated by reference numeral 246.

It is appreciated that each absorber member may be configured in any suitable manner so as to allow a fluid to be heated internally therewithin and externally thereto by an outer surface thereof

Fluid enters the tubes 236 of solar radiation absorber 230 via an inlet manifold 250, which comprises a plurality of inlet conduits 252. Inlet conduits 252 are in fluid communication with tubes 236 on a bottom portion 254 thereof, as seen in the inset in FIG. 3. Inlet conduits 252 may be connected to tubes 236 in any suitable manner, e.g., by brazing each inlet conduit 252 to a corresponding tube 236. Inlet conduits 252 may be formed of an austenitic nickel-based superalloy such as that sold under the trade-name INCONEL®, or any other suitable material.

Inlet manifold 250 is in fluid communication with first inlet conduit assembly 110, thereby facilitating entry of fluid therefrom to solar radiation absorber 230. First inlet conduit assembly 110 comprises a conduit 264 formed of a longitudinal portion 262 engaged with an annular portion 266 via an angular portion 268. Annular portion 266 surrounds absorber 230 and may be disposed within a fluid chamber 270, constituting at least a portion of a receiver chamber, defined within a lower cavity of a surrounding thermal insulating element 280. Apertures 272 defined within annular portion 266 are configured to allow fluid to flow from inlet conduits 252 into annular portion 266.

Longitudinal portion 262 comprises on a top portion 274 thereof a peripheral protrusion 276 protruding therefrom. Longitudinal portion 262 protrudes from top portion 108 and may be attached thereto via fastening members 278, which may be screws or any other suitable arrangement, inserted within peripheral protrusion 276 and top portion 108.

Fluid exits the tubes 236 of solar radiation absorber 230 via an outlet manifold 290. which comprises a plurality of outlet conduits 292. Outlet conduits 292 are in fluid communication with tubes 236 on a top portion 294 thereof, as seen in the inset in FIG. 3. Outlet conduits 292 may be connected to tubes 236 in any suitable manner, e.g., by brazing each outlet conduit 292 to a corresponding tube 236. Outlet conduits 292 may be formed of an austenitic nickel-based superalloy such as that sold under the trade-name INCONEL®, or any other suitable material.

Outlet manifold 290 is in fluid communication with first outlet conduit assembly 112, thereby facilitating exit of fluid thereto from solar radiation absorber 230. First outlet conduit assembly 112 comprises a conduit 300 formed of a generally cylindrical central portion 302 engaged with an annular portion 306 via a plurality of angular portions 308. Annular portion 306 overlies absorber 230 and may be disposed within a fluid chamber 310 defined within an upper cavity of surrounding thermal insulating element 280. Apertures 312 defined within annular portion 306 are formed to allow fluid to flow from outlet conduits 292 into annular portion 306.

Central portion 302 comprises on a top portion 314 thereof a peripheral protrusion 316 protruding therefrom. Central portion 302 protrudes from top portion 108 and may be attached thereto via fastening members 318, which may be screws or any other suitable arrangement, inserted within peripheral protrusion 316 and top portion 108.

Thermal insulating element 280 is provided to prevent heating of receiver housing cylindrical portion 104 by relatively high temperature fluid flowing through absorber 230. Thermal insulating element 280 may be formed of a ceramic material or any other suitable material.

It is appreciated that thermal insulating element 280 may be configured in any suitable manner, such as in the form of a plurality of thermal insulating elements, for example.

Second outlet conduit assembly 116 comprises a conduit 330 (FIG. 4) within a thermal insulating element 332 which extends out of thermal insulating element 280. Conduit 330 is in fluid communication with fluid chamber 310. Conduit 330 may be formed of any suitable material, e.g., stainless steel. Surrounding conduit 330 is a thermal insulating element 336 provided to thermally insulate conduit 330 so as to minimize emission of heat from the working fluid via conduit 330 as it flows therethrough.

Conduit 330 comprises on a top portion 340 thereof a peripheral protrusion 342 protruding therefrom. Peripheral protrusion 342 is attached to a peripheral protrusion 344. Peripheral protrusion 344 protrudes from a rim 346 of an outlet housing 348 and is mounted onto peripheral protrusion 342 via fastening members 349, which may be screws or any other suitable arrangement.

As seen in the inset in FIG. 2, a circumferential seal 350 is engaged with window 222 and is supported by base portion 106. Underlying base portion 106 is a cooling channel housing 354. Cooling channel housing 354 may be engaged with a circumferential cord 356 disposed between cooling channel housing 354 and window 222. Seal 350 and cord 356 are provided to prevent fluid which flows along outer surface 232 of window 222 from flowing along an inner surface 360 of window 222. Cooling channel housing 354 may be formed of stainless steel or any other suitable material.

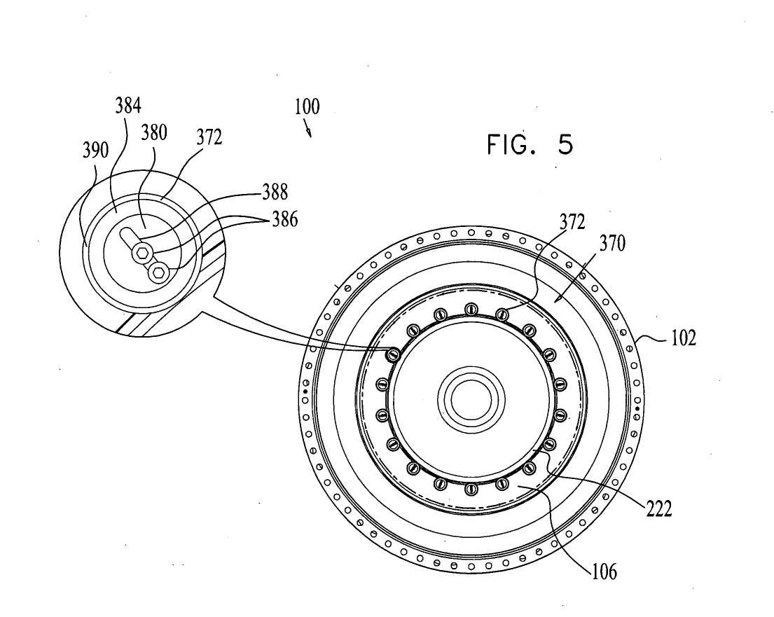

As seen in FIGS. 2 and 5, base portion 106 supports thereon a window mounting assembly 370 disposed adjacent to outer window surface 232. Window mounting assembly 370 may comprise a plurality of mounting elements 372. Mounting elements may be formed of a circular base 380 with a peripheral wall 382 extending upward therefrom. Peripheral wall 382 is attached to a ring 384 mounted thereon. Circular base 380 may be attached to base portion 106 by fastening members 386, which may be screws or any other suitable arrangement, inserted within a recess 388 formed within circular base 380. Mounting elements 372 are provided to support a cord 390 seated adjacent to an external surface 392 of wall 382 and underlying ring 384.

A plurality of mounting elements 372 may be circularly disposed along base portion 106. Mounting elements 372 may be formed of any suitable material, e.g., stainless steel. Cords 390 may be formed of any suitable material, e.g., a ceramic material.

Window 222 is configured to be tightly engaged with seal 350 due to a force exerted by window 222 on seal 350 during operation of receiver 100 wherein the receiver 100 is pressurized. Upon cessation of operation of the receiver 100, wherein the receiver 100 is unpressurized, window mounting assembly 370 is configured to exert a force on window 222 via cords 390 so as to ensure window 222 is secured to seal 350.

A window cooling system 400 may be provided so as to cool window 222 during impingement of solar radiation thereon. Window cooling system 400 may comprise an inlet cooling fluid conduit 402 designed to allow a fluid, such as the working fluid, to flow therewithin and therealong to a cooling fluid channel 406 defined within a bore 410 formed within cooling fluid housing 354 and base portion 106. Cooling fluid exits fluid channel 406 via a cooling fluid outlet 420.

It is appreciated that window 222 may be cooled by any suitable means.

A thermal insulating element 440 may be provided to underlie window 222 so as to prevent solar radiation from impinging on window cooling system 400 and base portion 106, so as to prevent heating of these components. Thermal insulating element 440 may be formed of any suitable material, e.g., a ceramic material.

As seen in FIG. 6, which is not shown to scale, solar radiation, designated by reference numeral 600, is concentrated by a concentrator 602 of a solar energy system 610 and impinges on window 222 of receiver 100 so as to heat absorber members, e.g., tubes 236, of absorber 230.

A working fluid, e.g., air, enters a compressor 620, typically at an ambient temperature of approximately 25° C. and a pressure of approximately 1 bar. Compressed fluid exits compressor 620, typically at a pressure of approximately 27 bar, and is introduced into receiver 100 via inlet cooling fluid conduit 402 of window cooling system 400. The working fluid flows within cooling fluid channel 406 so as to cool window 222, which is heated by solar radiation 600 impinging thereon. The working fluid flows out of window cooling system 400, via cooling fluid outlet 420, at a slightly elevated temperature, such as 30° C. and a pressure of approximately 27 bar.

The working fluid flows via conduits (not shown) and may be introduced into a recuperator 630 for further heating thereof.

The working fluid exiting recuperator 630 at an elevated temperature, such as a temperature in the range of 400° C.-600° C., typically 550° C., and at a pressure substantially the same as which it entered, is introduced into first inlet conduit assembly 110 of receiver 100.

Recuperator 630 may be any suitable device, such as a heat-exchanger.

A flow control valve 634 may be provided in the flow path between recuperator 630 and receiver 100 so as to selectively allow working fluid to flow either via recuperator 630, wherein heating of working fluid flowing from cooling fluid outlet 420 is required, or to bypass recuperator 630 and flow directly to first inlet conduit assembly 110, wherein additional heating of the working fluid is not required.

The working fluid flows into inlet manifold 250 via longitudinal portion 262 of first inlet conduit assembly 110.

The working fluid is introduced into tubes 236 of absorber 230 via inlet manifold 250. The working fluid flowing within tubes 236 is heated therein and thereafter exits absorber 230 via outlet manifold 290 at an elevated temperature, such as a temperature in the range of 800° C.-1200° C., typically 1000° C., and at a pressure substantially the same as which it entered. The working fluid flows out of receiver 100 via first outlet assembly 112 and on to a high-pressure power generation assembly 640.

The heated working fluid is introduced into a turbine 644 of high-pressure power generation assembly 640 for generation of electrical energy therefrom via a shaft 646. A combustor 650 may be disposed intermediate receiver 100 and turbine 644. Combustor 650 may be provided for supplemental heating during times the solar radiation 600 is insufficient to heat the absorber 230 and in turn is insufficient to heat fluid within receiver 100 to a desired temperature.

A flow control valve 654 may be provided in the flow path between receiver 100 and combustor 650 so as to selectively allow working fluid to flow either to combustor 650 wherein supplemental heat is required, or to bypass combustor 650 wherein supplemental heat is not required.

Exhaust working fluid exits from turbine 644 at a temperature and pressure lower than temperature and pressure of working fluid entering the turbine 644. The exhaust working fluid may exit turbine 644 at a temperature of 550° C. and a pressure of 5 bar and be introduced into second inlet conduit assembly 114.

The working fluid flows from inlet conduit 142 via radiation shield 192 into fluid channel 234. Working fluid flows from fluid channel 234 to absorber fluid chamber 270. The working fluid thereafter flows around tubes 236 of absorber 230 and is thereby heated by external surface 246 of tubes 236. The heated working fluid exits absorber 230 at an elevated temperature, such as a temperature in the range of 800° C.-1200° C., typically 1000° C., and at a pressure substantially the same as which it entered. The working fluid flows into fluid chamber 310 and out of receiver 100 via second outlet assembly 116 and on to a low-pressure power generation assembly 660.

The heated working fluid is introduced into a turbine 664 of low-pressure power generation assembly 660 for generation of electrical energy therefrom via a shaft 666. A combustor 670 may be disposed in the flow path between receiver 100 and turbine 664. Combustor 670 may be provided for supplemental heating during times the solar radiation 600 is insufficient to heat the absorber 230 and in turn is insufficient to heat fluid within receiver 100 to a desired temperature.

A flow control valve 674 may be provided in the flow path between receiver 100 and combustor 670 so as to allow working fluid to flow to combustor 670 wherein supplemental heat is required or to direct the working fluid to bypass combustor 670 wherein supplemental heat is not required.

Exhaust working fluid exits from turbine 664 at a temperature and pressure lower than temperature and pressure of working fluid entering the turbine 664. Typically the exhaust working fluid exits turbine 664 at a temperature of 580° C. and a pressure of 1.1 bar, for example.

Exhaust fluid may be introduced into recuperator 630 and be utilized to heat incoming fluid from inlet cooling fluid conduit 402, as described hereinabove.

It is appreciated that the sequence of heating of the working fluid within absorber 230 may be alternated. For example, the working fluid may be first heated by external surfaces 246 of tubes 236 and thereafter heated within tubes 236. Alternatively, the working fluid may simultaneously flow within tubes 236 and along external surfaces 246 of tubes 236 and be heated thereby.

It is noted that solar energy system 610 may comprise a plurality of power generation assemblies.

It is appreciated that the turbines 644 and 664 and combustors 650 and 670 may be incorporated within receiver 100.

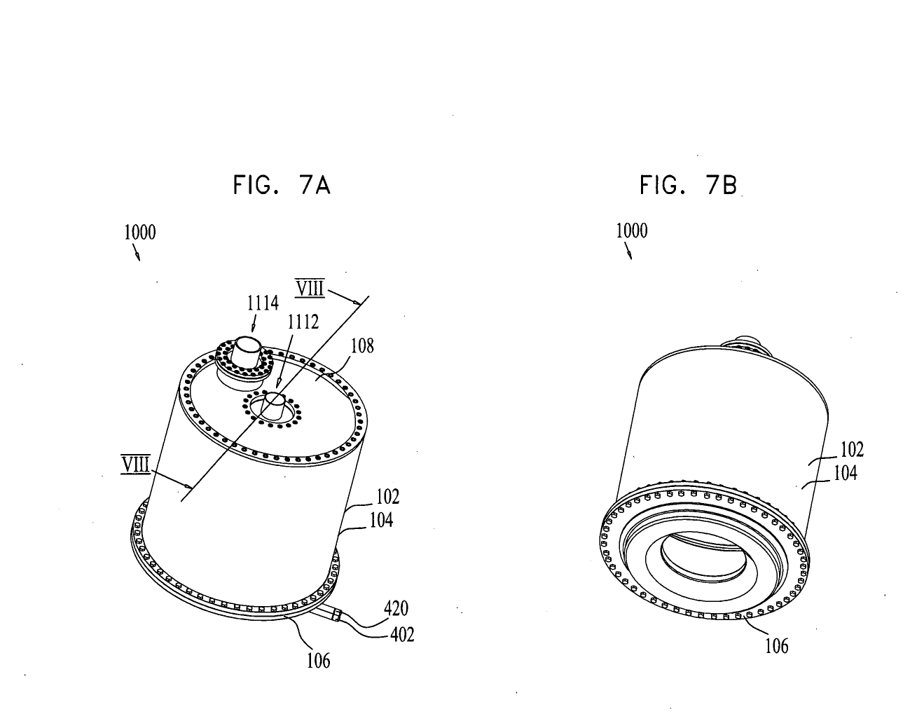

As seen in FIG. 7A, a solar receiver 1000 is provided comprising a fluid outlet conduit assembly 1112 and a fluid inlet conduit assembly 1114. (Many element of solar receiver 1000 described with reference to FIGS. 7A through 9 are identical to elements of receiver 100 described with reference FIGS. 1A through 6, and therefore will not be described with reference to FIGS. 7A through 9.) The fluid outlet conduit assembly 1112 and fluid inlet conduit assembly 1114 may be identical to respective first fluid outlet conduit assembly 112 and second fluid inlet conduit assembly 114 described hereinabove with reference to FIGS. 1A-6.

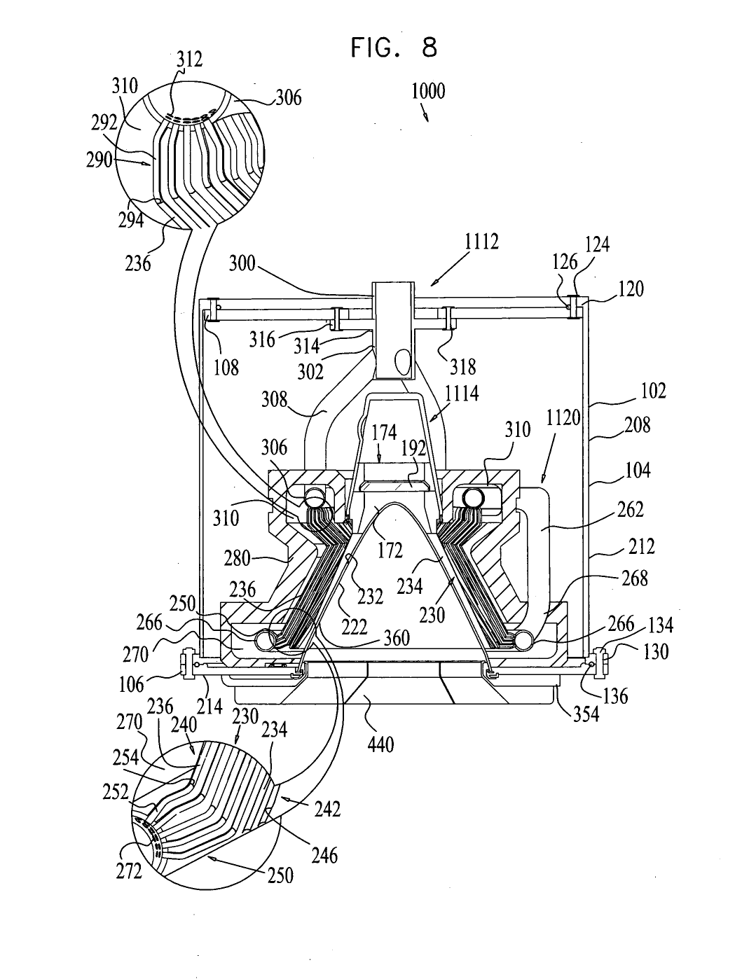

As seen in FIG. 8, a conduit 1120 is provided to allow fluid communication between annular portion 266 and fluid chamber 310.

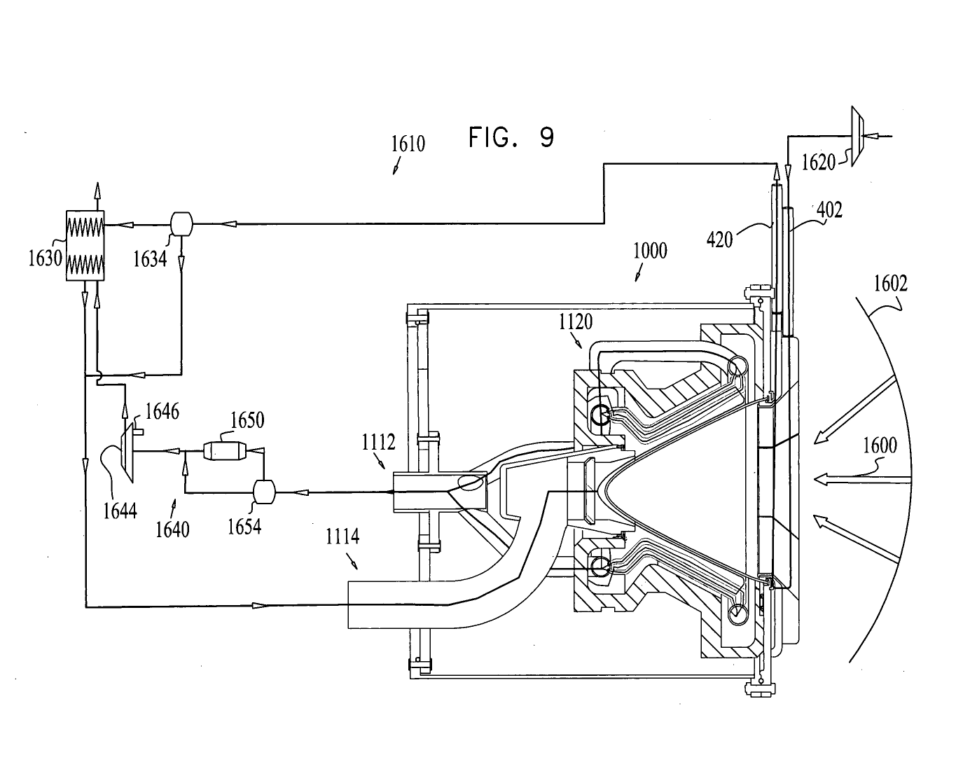

As seen in FIG. 9, which is not shown to scale, solar radiation, designated by reference numeral 1600, is concentrated by a concentrator 1602 of a solar energy system 1610 and impinges on window 222 of receiver 1000 so as to heat absorber members, e.g., tubes 236, of absorber 230.

A working fluid, e.g., air, enters a compressor 1620, typically at an ambient temperature of approximately 25° C. and a pressure of approximately 1 bar. Compressed fluid exits compressor 1620, typically at a pressure of approximately 27 bar, and is introduced into receiver 1000 via inlet cooling fluid conduit 402 of window cooling system 400. The working fluid flows within cooling fluid channel 406 so as to cool window 222, which is heated by solar radiation 1600 impinging thereon. The working fluid flows out of window cooling system 400, via cooling fluid outlet 420, at a slightly elevated temperature, such as 30° C. and a pressure of approximately 27 bar.

The working fluid flows via conduits (not shown) and may be introduced into a recuperator 1630 for further heating thereof.

The working fluid exiting recuperator 1630 at an elevated temperature, such as a temperature in the range of 400° C.-600° C., typically 550° C., and at a pressure substantially the same as which it entered, is introduced into fluid inlet conduit assembly 1114 of receiver 1000.

Recuperator 1630 may be any suitable device, such as a heat-exchanger.

A flow control valve 1634 may be provided in the flow path between recuperator 1630 and receiver 1000 so as to selectively allow working fluid to flow either via recuperator 1630, wherein heating of working fluid flowing from cooling fluid outlet 420 is required, or to bypass recuperator 1630 and flow directly to fluid inlet conduit assembly 1114, wherein additional heating of the working fluid is not required.

The working fluid flows from inlet conduit 142 of inlet conduit assembly 1114, via radiation shield 192, on to fluid channel 234. Working fluid flows from fluid channel 234 to absorber fluid chamber 270. The working fluid thereafter flows around tubes 236 of absorber 230 and is thereby heated by external surface 246 of tubes 236.

The heated working fluid exits absorber 230 at an elevated temperature, such as a temperature in the range of 800° C.-1200° C., typically 800° C., and at a pressure substantially the same as which it entered. The heated working fluid flows into fluid chamber 310 and on to conduit 1120. The working fluid flows from conduit 1120 to annular portion 266 wherein the working fluid is introduced into tubes 236 of absorber 230 via inlet manifold 250. The working fluid flowing within tubes 236 is heated within tubes 236 and thereafter exits absorber 230, via outlet manifold 290, at an elevated temperature, such as a temperature in the range of 800° C.-1200° C., typically 1000° C., and at a pressure substantially the same as which it entered. The working fluid flows out of receiver 1000 via fluid outlet conduit assembly 1112 and on to a power generation assembly 1640.

The heated working fluid is introduced into a turbine 1644 of power generation assembly 1640 for generation of electrical energy therefrom via a shaft 1646. A combustor 1650 may be disposed intermediate receiver 1000 and turbine 1644. Combustor 1650 may be provided for supplemental heating during times the solar radiation 1600 is insufficient to heat the absorber 230 and in turn is insufficient to heat fluid within receiver 1000 to a desired temperature.

A flow control valve 1654 may be provided intermediate receiver 1000 and combustor 1650 so as to selectively allow working fluid to flow either to combustor 1650 wherein supplemental heat is required, or to bypass combustor 1650 wherein supplemental heat is not required.

Exhaust working fluid exits from turbine 1644 at a temperature and pressure lower than temperature and pressure of working fluid entering the turbine 1644. Typically the exhaust working fluid exits turbine 1644 at a temperature of 580° C. and a pressure of 1.1 bar, for example.

Exhaust fluid may be introduced into recuperator 1630 and be utilized to heat incoming fluid from inlet cooling fluid conduit 402, as described hereinabove.

It is appreciated that the sequence of heating of the working fluid within absorber 230 may be alternated. For example the working fluid may be first heated within tubes 236 and thereafter by external surfaces 246 of tubes 236. Alternatively, the working fluid may simultaneously flow within tubes 236 and along external surfaces 246 of tubes 236 and be heated thereby.

It is noted that solar energy system 1610 may comprise a plurality of power generation assemblies.

It is appreciated that the turbine 1644 and combustor 1650 may be incorporated within receiver 1000.

It is noted that solar receivers 100 and 1000 may be incorporated in solar thermal systems, such as on-axis or off-axis tracking solar thermal systems. The on-axis tracking solar system is known in the art as a solar system wherein the target, e.g., a solar receiver, is always kept on a center-line formed between a solar reflector (or reflectors) and the sun, with the target (e.g., solar receiver) location continuously changing in accordance with the movement of the sun. Examples of on-axis tracking solar systems include parabolic dish reflectors/concentrators and Fresnel lens concentrators. In off-axis tracking solar systems the target (e.g., solar receiver) may be stationary or may move, but is generally not kept in the center-line formed between the reflector (or reflectors) and the sun. Examples of off-axis tracking solar systems include central solar receivers such as solar towers.

It will be appreciated by persons skilled in the art that the present invention is not limited by what has been particularly shown and described herein above. Rather the scope of the present invention may include combinations and/or subcombinations of the various features described hereinabove, and may further include variations and modifications which would occur to persons skilled in the art upon reading the specification.

1. A solar receiver for receiving concentrated solar radiation and heating a working fluid, the solar receiver comprising:
a housing having a front, radiation-facing, end and a rear end, the front end being formed with a cavity therein;
a window mounted at the front end of the housing and projecting inside the cavity;
a receiver chamber defined within the cavity between the housing and the window, the receiver chamber having a working fluid inlet for ingress of working fluid to be heated therewithin, and a working fluid outlet for egress therethrough of the heated fluid; and
a solar absorber within the receiver chamber for absorbing the solar radiation and heating the working fluid, the solar absorber comprising at least one tubular member configured for maintaining fluid isolation between contents thereof and contents of the receiver chamber, the solar absorber being configured for heating:
working fluid within the receiver chamber exterior to the tubular member; and
working fluid within the tubular member.

2. The solar receiver according to claim 1, the window and cavity being elongated toward the rear end of the housing, the solar absorber extending around and along the window.

3. The solar receiver according to claim 1, the receiver chamber being in fluid communication with the interior of the solar absorber via at least one of the working fluid inlet and working fluid outlet.

4. The solar receiver according to claim 1, further comprising a radiation shield disposed within a fluid path between the working fluid inlet and the absorber.

5. The solar receiver according to claim 1, wherein an outlet of the solar absorber is in fluid communication with a first turbine.

6. The solar receiver according to claim 5, wherein a first combustor is located between the solar absorber and the first turbine.

7. The solar receiver according to claim 5, wherein an outlet of the first turbine is in fluid communication with the working fluid inlet of the receiver chamber.

8. The solar receiver according to claim 1, wherein the working fluid outlet of the receiver chamber is in fluid communication with a second turbine.

9. The solar receiver according to claim 8, wherein a second combustor is located between the solar absorber and the second turbine.

10. The solar receiver according to claim 1, wherein the working fluid outlet of the receiver chamber is in fluid communication with an inlet of the solar absorber.

11. The solar receiver according to claim 1, further comprising a pre-heater at the entrance of the working fluid inlet.

12. The solar receiver according to claim 11, wherein the pre-heater is a heat exchanger.

13. The solar receiver according to claim 1, wherein the solar absorber is configured to maintain the working fluid therewithin at a first pressure when the pressure of the working fluid within the receiver chamber is at a second pressure, the pressure difference between the first and second pressures being substantially greater than 10 bar.

14. The solar receiver according to claim 13, wherein the pressure difference between the first and second pressures is substantially greater than 20 bar.

15. The solar receiver according to claim 1, further comprising a cooling system configured to maintain a low temperature at the area of contact between the window and the housing.

16. The solar receiver according to claim 15, wherein the cooling system comprises a cooling fluid path adjacent or concurrent with the area.

17. The solar receiver according to claim 16, wherein the cooling fluid path is in fluid communication with at least one of the receiver chamber and the interior of the solar absorber.

18. The solar receiver according to claim 17, wherein the working fluid is used to drive a turbine, the solar receiver further comprising a recuperator, configured to utilize exhaust heat from the turbine to heat fluid, disposed between the cooling fluid path and the at least one of the receiver chamber and the interior of the solar absorber.

19. The solar receiver according to claim 1, wherein the window is formed comprising a paraboloid of revolution.

20. The solar receiver according to claim 1, being a central solar receiver.

21. The solar energy system comprising:
a solar receiver according to claim 1; and
a turbine configured to receive the fluid exiting the working fluid outlet and utilize the fluid to generate electricity.
